(19) United States
(12) Patent Application Publication
(10) Pub. No.: US 2025/0298193 A1
(43) Pub. Date: Sep. 25, 2025

(54) Closed Latch Integrated with Tapered Housing for VSFF Connectors

(71) Applicant: US Conec Ltd., Hickory, NC (US)

(72) Inventors: Jason Higley, Hickory, NC (US); Darrell R. Childers, Hickory, NC (US); Shubhrangshu Sengupta, Hickory, NC (US)

(21) Appl. No.: 19/086,510

(22) Filed: Mar. 21, 2025

Related U.S. Application Data
(60) Provisional application No. 63/568,314, filed on Mar. 21, 2024.

(51) Int. Cl. G02B 6/38; G02B 6/40

(52) U.S. Cl. CPC G02B 6/3831; G02B 6/403

(57) ABSTRACT

A closed latch mechanism is integrally molded with a housing such that a rear end of the closed latch mechanism is joined to the main body rearward of the transition portion and a front end of the closed latch mechanism is joined to the main body forward of the rear end of the closed latch mechanism. There is a gap between the housing body and the closed latch mechanism between the front end and the rear end of the closed latch mechanism thereby allowing the closed latch mechanism to deflect between a first position and a second position.

### REFERENCE TO RELATED CASE

This application claims priority under 35 U.S.C. § 119 (e) to U.S. provisional application No. 63/568,314 filed on Mar. 21, 2024, the contents of which are hereby incorporated by reference in their entirety.

### BACKGROUND OF THE INVENTION

Recently, very small form-factor (VSFF) fiber optic connectors (“connectors”) have been introduced. These connectors occupy about a third of the space of conventional LC-duplex and MPO connectors in terms of their footprint on an adapter panel. As a result, these connectors are also densely packed in the adapter panel, for example, inside a data center. The tight space between the individual side-by-side connectors may make it challenging to insert or remove a connector into or from, respectively, a high density adapter panel on a rack unit.

One solution proposed by the Applicant is the use of a push-pull boot that also can actuate a latching arrangement to secure the connector into an adapter, described for example, in Applicant's U.S. Pat. No. 11,592,627 and commonly known as the MDC connector (or, the MMC connector for the multi-fiber version). See also FIGS. 1A and 1B. VSFF connectors with jacketed cables have a strain relief connection with a crimp band that secures aramid yarn to a crimp body on the connector. However, many applications in industry do not require a secure connection with aramid yarn or a boot for strain relieving the optical fibers inside the optical fiber cable. For example, a ribbonized fiber connector may not require a strain relief boot solution. In addition, a secondary transition piece from the fiber ribbon to engage a round cable, such as a furcation tube or mesh fiber cover is also provided for attachment to the housing. These solutions do not typically include the strain relieving aramid yarn and may be joined with the transition piece by way of heat shrink tube.

Another solution used in the industry that does not use a push-pull boot includes a cantilevered latch such as the one used on the MXC® brand connector sold by the Applicant. These latches have a free end (see FIGS. 2A and 2B). The common issue with this type of a latch is that when routing cables in tight spaces, the latch can act as a catch point, commonly referred to as the “fish hook” effect. One typical solution to address this effect is the addition of a separate thumb pad behind the latch. However, the addition of the thumbpad does require an additional piece in the assembly. The ability to reduce part count is important when considering the cost of the product family.

### SUMMARY OF THE INVENTION

According to one aspect, the present invention is directed to a fiber optic connector configured to support at least two optical fibers that includes a housing having a main body with a top wall and a bottom wall joined to each other by two opposite side walls and extending between a front end and a rear end, a separation between the top wall and the bottom wall at the front end is more than a separation between the two opposite side walls, the front end defining a front opening through which the at least two optical fibers pass and the rear end defining a rear opening that is smaller than the front end opening, the main body also having a transition portion integrally molded with the main body and disposed between the front end and the rear end of the main body such that the main body has a reduction in cross section in a rearward direction towards the rear end, and a closed latch mechanism integrally molded with the main body such that a rear end of the closed latch mechanism is joined to the main body rearward of the transition portion and a front end of the closed latch mechanism is joined to the main body forward of the rear end of the closed latch mechanism, wherein there is a gap between the main body and the closed latch mechanism between the front end and the rear end of the closed latch mechanism thereby allowing the closed latch mechanism to deflect between a first position and a second position.

In some embodiments, the closed latch mechanism also includes a latch configured to secure the fiber optic connector to a telecommunications structure; and a stiffening rib in a middle portion of the closed latch mechanism rearward of the latch.

In some embodiments, the rear portion of the closed latch mechanism is flexible or compliant upon an application of an external force and the closed latch mechanism deflects between the first position and the second position, wherein the rear portion includes the rear end of the closed latch mechanism.

In some embodiments, the rear end of the main body includes a plurality of connection features configured to receive a heat shrink directly thereupon.

In some embodiments, individual connection features of the plurality of connection features are disjointed from each other circumferentially about the rear end of the main body thereby allowing the heat shrink to collapse thereinto upon application of heat during assembly of the fiber optic connector

In some embodiments, the main body further includes an anti-buckle feature disposed between the closed latch mechanism and the main body and located forward of the transition portion.

In some embodiments, the anti-buckle feature is on the main body and in some the anti-buckle feature is on the closed latch mechanism.

In some embodiments, the housing comprises a ferrule receiver configured to seat the single multi-fiber ferrule therein.

In some embodiments, the at least two optical fibers transition from a loose arrangement to ribbonized arrangement inside the main body at the transition portion.

In some embodiments, the housing is a two-piece housing.

In some embodiments, the stiffening rib is on an outside surface of the closed latch mechanism.

In some embodiments, the stiffening rib is on an underside surface of the closed latch mechanism.

In some embodiments, upon a full insertion into a telecommunication structure, at least a rear portion of the closed latch mechanism is exposed and is compliant to deflect between the first position and the second position.

In yet another aspect, there is a bag of parts that includes the housing with the closed latch mechanism integrally molded with the housing.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of a multi-fiber connector with a push-pull boot having a latching mechanism;

FIG. 2 is a side perspective view the another connector with a cantilevered latch;

FIG. 3 is a perspective view from the front left of one embodiment of a fiber optic connector according to the present invention;

FIG. 4 is a perspective view from the right rear of the fiber optic connector in FIG. 3;

FIG. 5 is a cross section view of the fiber optic connector in FIG. 3;

FIG. 6 is a perspective view from the right rear of one embodiment of a housing that can be used with the fiber optic connector in FIG. 3;

FIG. 7 is a perspective view from the left front of the housing in FIG. 6;

FIG. 8 is a cross sectional view of the housing in FIG. 6;

FIG. 9 is an elevational view of the housing in FIG. 6 from the rear;

FIG. 10 is a side view of the housing showing the application of force on the housing;

FIG. 11 is a side view of the housing showing the application of force on the housing and the deflection of the latch;

FIG. 12 is a perspective view from the front left of another embodiment of a fiber optic connector according to the present invention;

FIG. 13 is a perspective view from the bottom right of the fiber optic connector in FIG. 12;

FIG. 14 is a perspective view of the fiber optic connector in FIG. 12 with one side of the housing removed;

FIG. 15 is a perspective view of the other side of the housing of the fiber optic connector in FIG. 12;

FIG. 16 is a perspective view of fiber optic connectors installed in a telecommunications structure; and

FIG. 17 is a cross section of another embodiment of a fiber optic connector according to the present invention.

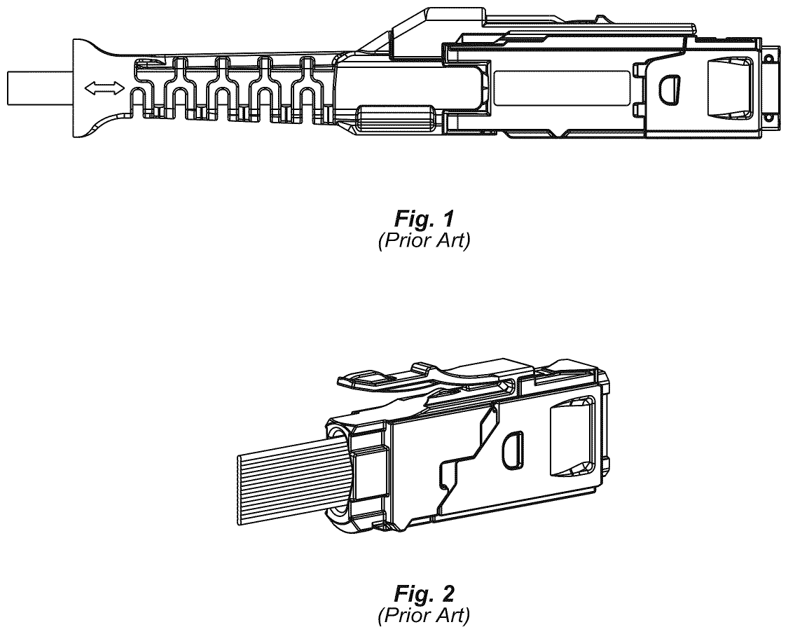

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

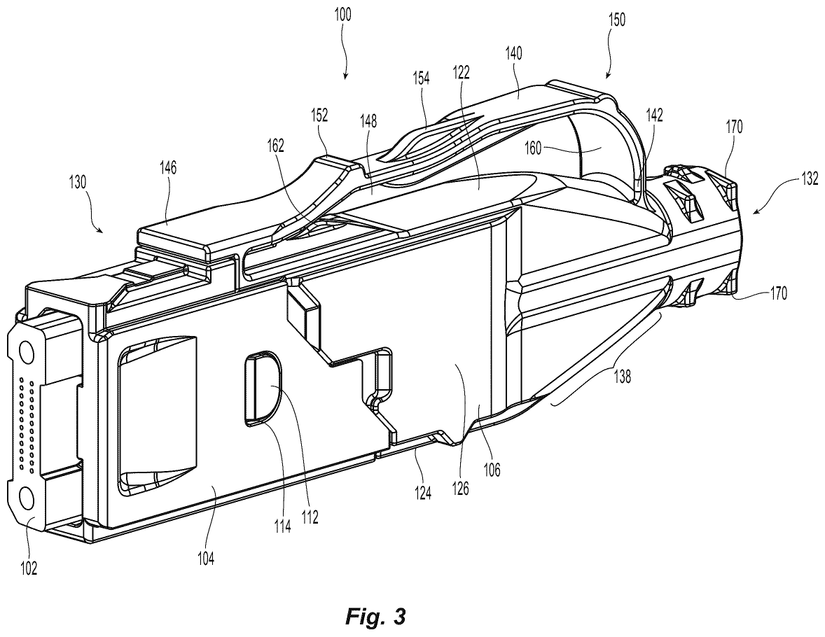

Applicant notes that the term “front” or “forward” means that direction where the fiber optic ferrule would meet with another fiber optic ferrule or device, while the term “rear” or “rearward” is used to mean the direction from which the optical fibers enter into the fiber-optic ferrule or fiber optic connector. In the present application, the fiber optic connector 100 will therefore have a front and a rear, the front will be inserted into the telecommunication structure (or adapter or other mating structure) to mate with another fiber optic connector. Thus, in FIG. 3, the “front” of the connector 100 (and also a fiber optic ferrule) is on the left side of the figure and pointing out of the figure. The “rear” or “back” is that part of the fiber optic connector 100 is on the right side of the page and “rearward” and “backward” is toward the right and into the page.

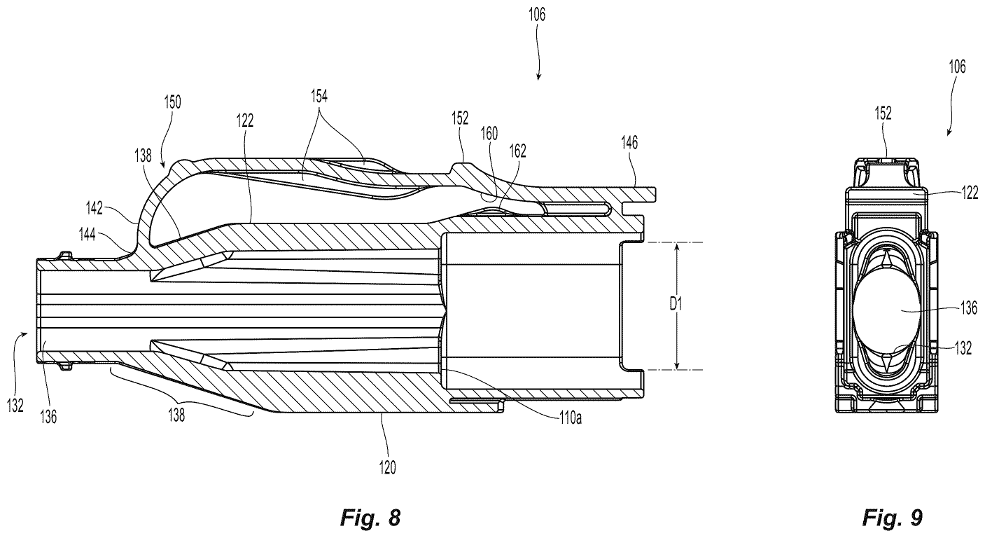

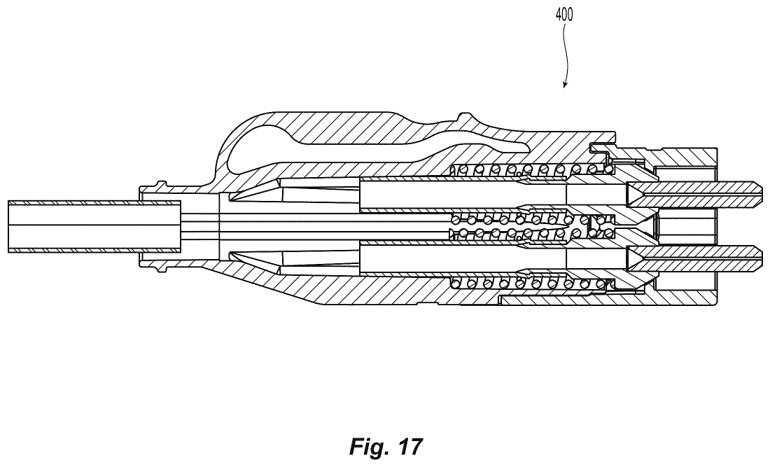

Illustrated in FIGS. 3-5 is one embodiment of a fiber optic connector 100 according to the present invention. The fiber optic connector 100 includes a ferrule 102, a ferrule receiver 104, and a housing 106. The fiber optic connector 100 will also include optical fibers 108, which may take different formats (ribbon, individual, bundled, etc.). There are at least two optical fibers 108 present. The optical fibers 108 herein may be multi-mode or single mode and this disclosure is not limited by the type of optical fibers 108. The fiber optic connector 100 may also include a spring 110, to ensure that the fiber optic connectors 100 can appropriately mate within the telecommunications structure as needed. There is also a forward facing surface 110a to engage the spring 110. See FIG. 8. The ferrule 102 may be a multi-fiber ferrule, or there may be multiple single fiber ferrules with individual springs. See, e.g., FIG. 17 below.

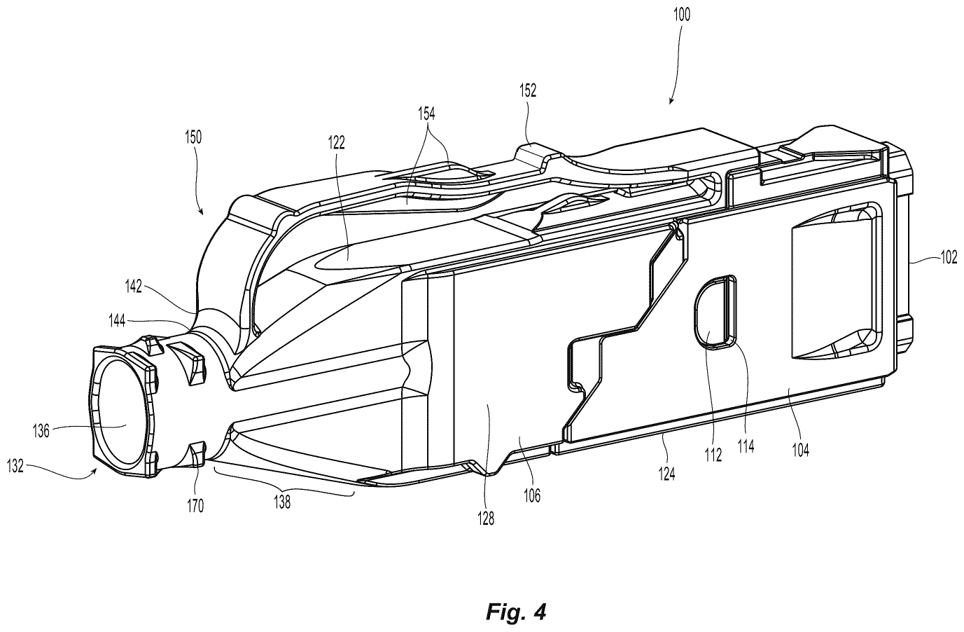

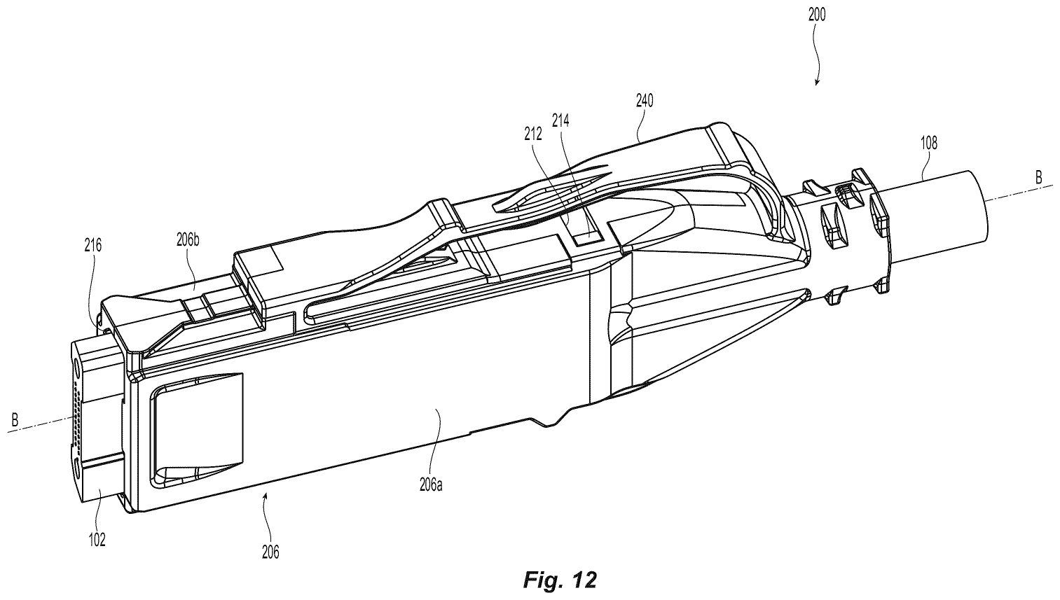

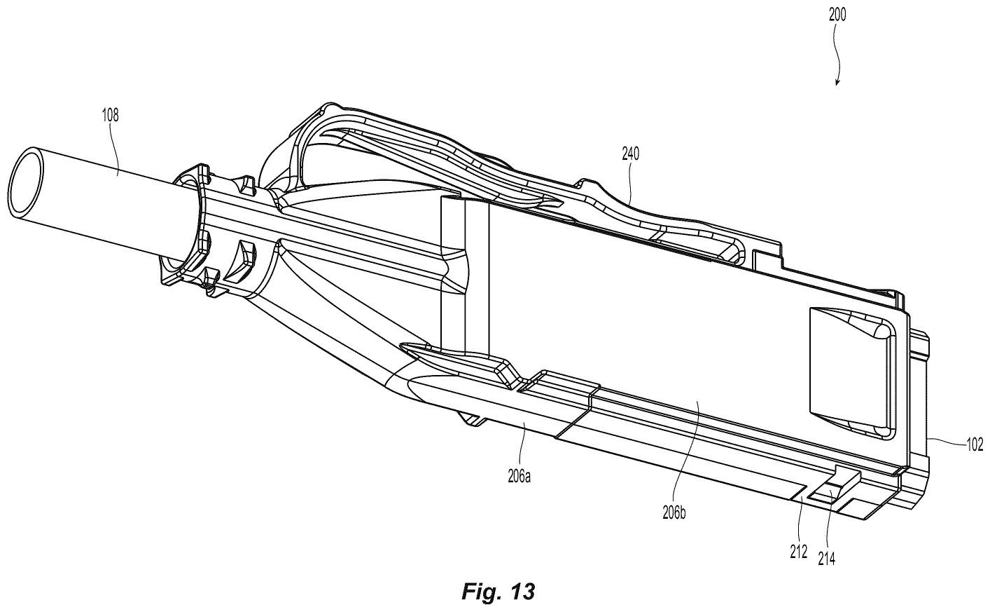

The ferrule 102 and the ferrule receiver 104 in this embodiment mate with the housing 106. Alternatively, the ferrule receiver 104 may be molded together with the housing 106, at least in part. See, e.g., FIGS. 12-15. The housing 106 has a side latch 112 that matches with an opening 114 in the ferrule receiver 104. There may be one side latch 112 on each of opposing sides of the fiber optic connector 100. See FIGS. 3 and 4. Other configurations of the ferrule and ferrule receiver for another fiber optic connector are disclosed in Applicant's U.S. Pat. No. 11,914,195 (Atty. Dkt. USCO-135A-US), the contents of which are incorporated by reference in their entirety. There is also another housing that is used with the fiber optic connector in the '195 patent. There are also other ferrule holders, such as the one in Applicant's application published as WO/2022/212934 (Atty. Dkt. USCO-144-INT), the contents of that application also incorporated herein by reference.

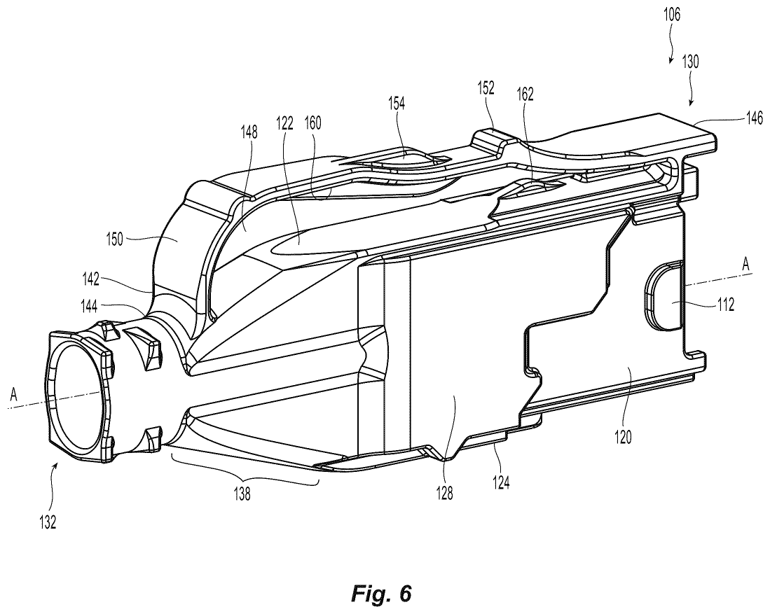

The housing 106 has a main body 120 with a top wall 122 and a bottom wall 124 joined to each other by two opposite side walls 126,128 and extending between a front end 130 and a rear end 132. There is a separation (D1) between the top wall 122 and the bottom wall 124 at the front end 130 that is more than a separation (D2) between the two opposite side walls 126,128. The front end 130 defines a front opening 134 through which the at least two optical fibers 108 pass and the rear end 132 defines a rear opening 136 that is smaller than the front end opening 134. See FIGS. 6-8.

The main body 106 also has a transition portion 138 integrally molded with the main body 106 and it is disposed between the front end 130 and the rear end 132 of the main body 106 such that the main body 106 has a reduction in cross section in a rearward direction towards the rear end 132. It is in this area of the transition portion 138, the optical fibers 108 can transition from a loose arrangement to ribbonized arrangement inside the main body 106 at the transition portion 138.

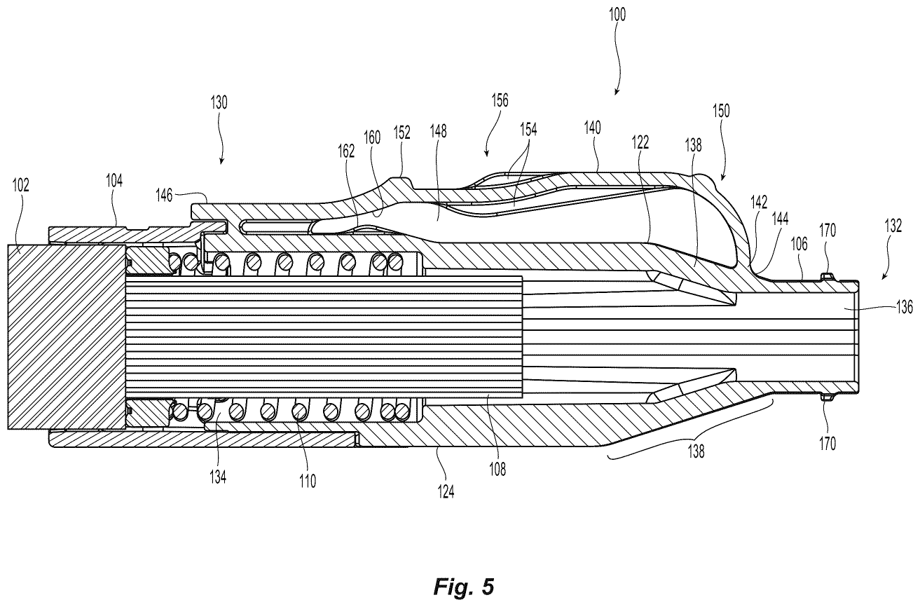

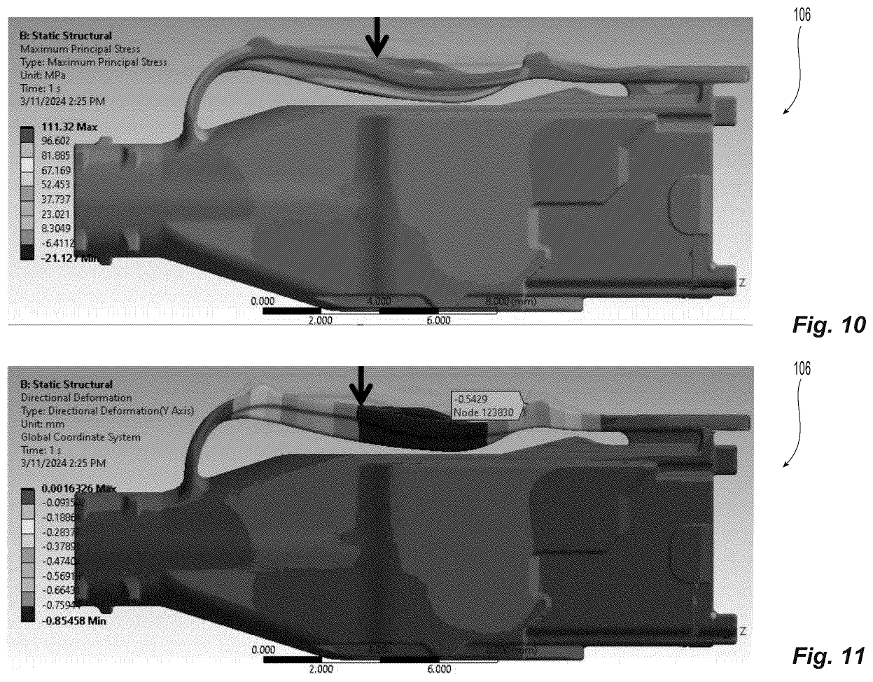

Next, a closed latch mechanism 140 is integrally molded with the main body 106 such that a rear end 142 of the closed latch mechanism 140 is joined to the main body 106 rearward of the transition portion 138 at a location 144. A front end 146 of the closed latch mechanism 140 is joined to the main body 106 forward of the rear end 142 of the closed latch mechanism 140. In this embodiment, the front end 146 of the closed latch mechanism 140 is attached to the main body 106 near the front end 130 thereof. It could also be attached farther back towards the rear end 132 of the main body 106. This configuration causes there to be a gap 148 between the main body 106 and the closed latch mechanism 140 between the front end 146 and the rear end 142 of the closed latch mechanism 140. This gap 148 allows for the closed latch mechanism 140 to deflect between a first position and a second position. Cf. FIGS. 5 and 10. The first position (FIG. 5) is where the closed latch mechanism 140 is in a relaxed position and the second position (FIG. 10) is where the closed latch mechanism 140 has had a force applied thereto. FIG. 11 shows the maximum deformation encountered by the closed latch mechanism 140, for example around where the latch 152 toward a middle of the closed latch mechanism 140 is located (displacement shown near the middle of the shade scale). That is, a rear portion 150 of the closed latch mechanism 140 is flexible or compliant upon an application of an external force and the closed latch mechanism 140 deflects between the first position and the second position as shown in FIGS. 5 and 10. The rear portion 150 includes the rear end 142 of the closed latch mechanism 140.

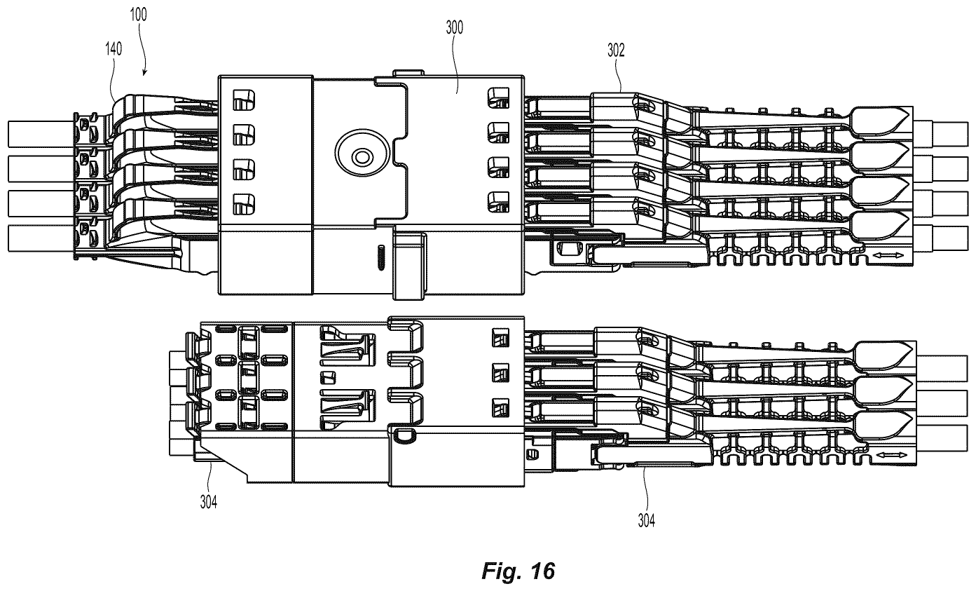

The closed latch mechanism 140 also includes a latch 152 configured to secure the fiber optic connector 100 to a telecommunications structure 300 (see FIG. 16) and a stiffening rib 154 in a middle portion 156 of the closed latch mechanism 120 and rearward of the latch 152. In the illustrated embodiment, the stiffening rib 154 is located on both an outside surface 158 of the close latch mechanism 140 and also on an underside surface 160 of the closed latch mechanism 140. However, the stiffening rib 154 may be only on the outside surface 158 or on the underside surface 160 and still fall within the scope of the present invention.

The main body 106 also includes an anti-buckle feature 162 disposed between the closed latch mechanism 140 and the main body 106, and located forward of the transition portion 138. The anti-buckle feature 162 keeps the front end of the closed latch mechanism from traveling too close to the top wall 122 and preventing the latch 152 from moving enough to allow the fiber optic connector 100 from being accidentally or unintentionally removed from telecommunications structure 300 (e.g., under a proof-load). The anti-buckle feature 162 is illustrated as being on the top wall 122, but it may also be on the underside surface 160 of the closed latch mechanism 140 and projecting into the gap 148.

Rearward of the transition portion 138 on the main body 106, the rear end opening 136 is surrounded by a plurality of connection features 170. Each of the individual connection features 170 is disconnected from the others circumferentially about the rear end opening 136. As a result, a heat shrink tube (not shown) can collapse into the space between two connection features 170 with the application of heat during assembly of the fiber optic connector 100.

Looking at the rear end 132 of the main body 106, the rear end 142 of the closed latch mechanism 120 (at the location 144) is lower than the front end 146 of the closed latch mechanism 120 between the top wall 122 and the bottom wall 124 of the housing 106. That causes the rear portion 150 of the closed latch mechanism 140 to be smooth and rounded.

The housing 106 and other components of the fiber optic connector 100 may also be included in a bag-of-parts, which is shipped to cable assembly houses that then assemble the components with optical fibers 108 to result in the final fiber optic connector 100.

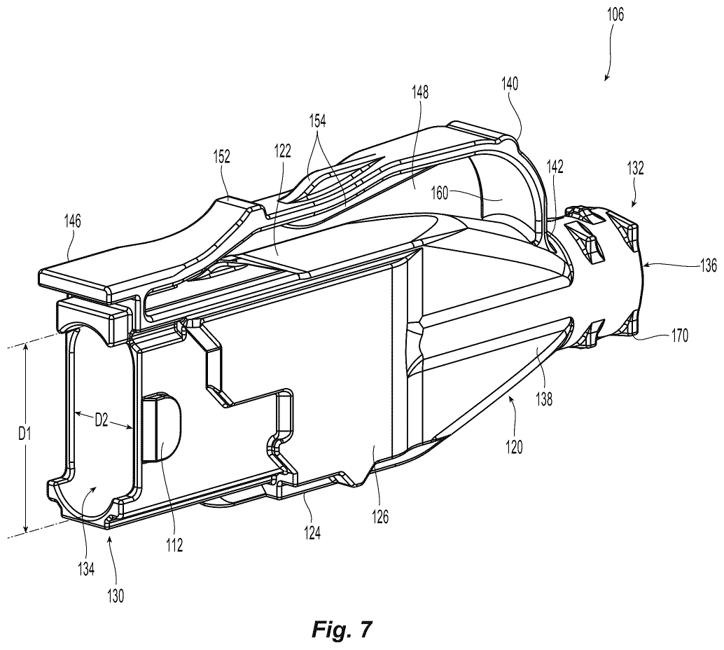

Another embodiment of a fiber optic connector 200 is illustrated in FIGS. 12-15. The fiber optic connector 200 has a ferrule 102 and a housing 206. Another fiber optic connector 400, with appropriate changes to the housing, could have two single-fiber ferrules as illustrated in FIG. 17. The fiber optic connector 200 may also have a spring 110 and optical fibers 108. The housing 206 is a two-piece housing that is split generally in the middle of housing 206 along a longitudinal axis B and in a plane parallel to the separation (D1) between the top wall 122 and the bottom wall 124 in FIG. 7. The housing 206 has a first portion 206a and a second portion 206b. The housing 206 will also have the closed latch mechanism 240, which is the same as the closed latch mechanism 140 discussed above. In this embodiment however, the closed latch mechanism 240 is only on one of the first and second portions 206a,206b, and is illustrated as being on first portion 206a, but could be on second portion 206b. The closed latch mechanism 240 will not be discussed further, except to the extent that different housings 106,206 require further explanation.

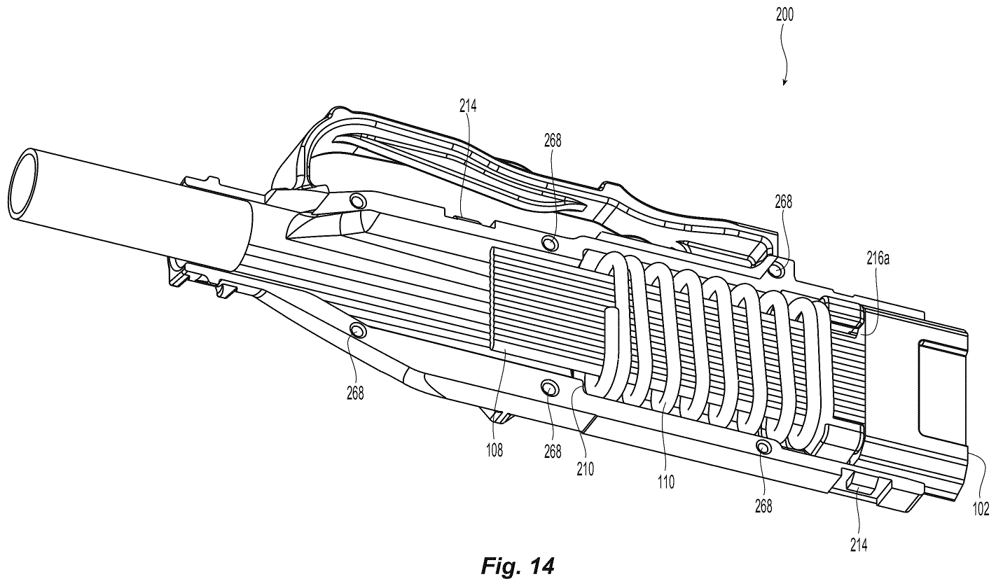

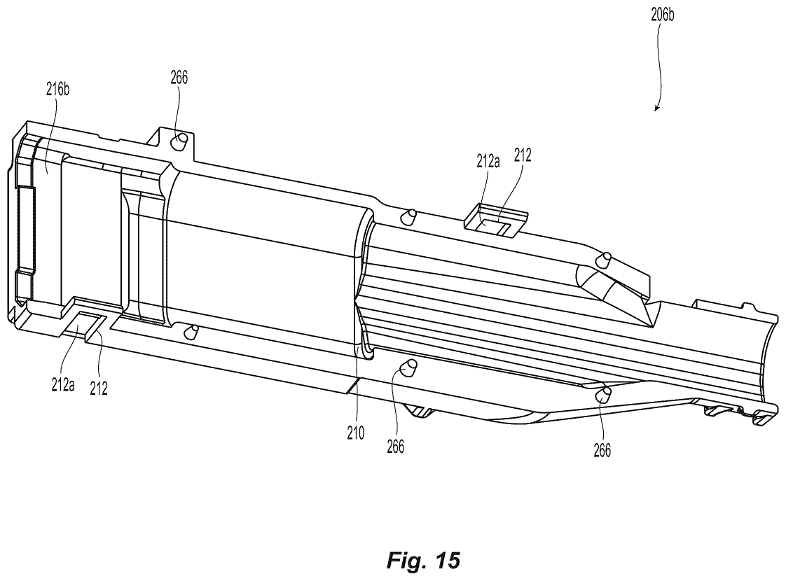

The housing 206 (both portions 206a and 206b) have a forward facing surface 210 to engage the spring 110. See FIGS. 14 and 15. There is also a cavity 216 to receive and support the ferrule 202. The cavity 216 is a combination of partial first cavity 216a in first portion 206a, and second partial cavity 216b in second portion 206b. One of the portions 206a, 206b have projections 266 that are placed and engage holes 268 on the other of the portions 206a, 206b. See FIGS. 14 and 15. These projections/holes cooperate with tabs 212 and bumps 214 to hold the housing 206 together. The tabs 212 are illustrated as being on second portion 206b, but could be on first portion 206a or on both portions 206a,206b. The tabs 212 have an opening 212a to received bumps 214 on the first portion 206a. The portions 206a,206b could also be connected via other methods, e.g., adhesives, ultrasonic welding, etc.

FIG. 16 shows an example environment in which the VSFF fiber optic connectors 100 with closed latch mechanism 140 are mated to conventional VSFF format connectors 302 (e.g., MMC or MDC brand fiber optic connectors) inside a telecommunication structure 300 (e.g., adapter, receptacle for optoelectronic devices, etc.). The closed latch mechanism 240 is exposed in the adapter and available to be moved between the first position and the second position. FIG. 16 also shows a conventional smaller version of conventional VSFF connector 304 (e.g., MDC “junior” provided by the Applicant) also mated to conventional VSFF connectors inside another type of a telecommunications structure. The MDC junior connectors are typically inside a cassette or a box and are not easy to remove without a specific tool. However, the presence of the closed latch mechanism in a similar setup inside a cassette allows a tool-less operation due to the increased length of the VSFF connectors relative to the MDC junior. As a result, a user can simply push on the thumb pad or the rear end of the closed latch mechanism to release the VSFF connectors from the telecommunications structure without the need for any tool.

Thus FIG. 16 illustrates a combination of a telecommunications structure and a fiber optic connector configured to support at least two optical fibers. The combination includes a telecommunications structure having at least two ports to receive at least two fiber optic connectors, and a fiber optic connector in the at least two fiber optic connectors includes a housing having a main body with a top wall and a bottom wall joined to each other by two opposite side walls and extending between a front end and a rear end. A separation between the top wall and the bottom wall at the front end is more than a separation between the two opposite side walls, the front end defining a front opening through which the at least two optical fibers pass and the rear end defining a rear opening that is smaller than the front end opening. The main body also has a transition portion integrally molded with the main body and disposed between the front end and the rear end of the main body such that the main body has a reduction in cross section in a rearward direction towards the rear end. A closed latch mechanism 140, 240 integrally molded with the main body is provided such that a rear end of the closed latch mechanism is joined to the main body rearward of the transition portion and a front end of the closed latch mechanism is joined to the main body forward of the rear end of the closed latch mechanism. There is a gap between the main body and the closed latch mechanism between the front end and the rear end of the closed latch mechanism thereby allowing the closed latch mechanism to deflect between a first position and a second position, wherein upon a full insertion into the telecommunication structure, at least a rear portion of the closed latch mechanism is exposed outside the telecommunications structure and is compliant to deflect between the first position and the second position.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A fiber optic connector configured to support at least two optical fibers comprising:
a housing having a main body with a top wall and a bottom wall joined to each other by two opposite side walls and extending between a front end and a rear end, a separation between the top wall and the bottom wall at the front end is more than a separation between the two opposite side walls, the front end defining a front opening through which the at least two optical fibers pass and the rear end defining a rear opening that is smaller than the front end opening;
the main body also having a transition portion integrally molded with the main body and disposed between the front end and the rear end of the main body such that the main body has a reduction in cross section in a rearward direction towards the rear end; and
a closed latch mechanism integrally molded with the main body such that a rear end of the closed latch mechanism is joined to the main body rearward of the transition portion and a front end of the closed latch mechanism is joined to the main body forward of the rear end of the closed latch mechanism, wherein there is a gap between the main body and the closed latch mechanism between the front end and the rear end of the closed latch mechanism thereby allowing the closed latch mechanism to deflect between a first position and a second position.

2. The fiber optic connector of claim 1, wherein the closed latch mechanism comprises:
a latch configured to secure the fiber optic connector to a telecommunications structure; and
a stiffening rib in a middle portion of the closed latch mechanism rearward of the latch.

3. The fiber optic connector of claim 1, wherein a rear portion of the closed latch mechanism is flexible or compliant upon an application of an external force and the closed latch mechanism deflects between the first position and the second position, wherein the rear portion includes the rear end of the closed latch mechanism.

4. The fiber optic connector of claim 1, wherein the rear end of the main body includes a plurality of connection features configured to receive a heat shrink directly thereupon.

5. The fiber optic connector of claim 4, wherein individual connection features of the plurality of connection features are disjointed from each other circumferentially about the rear end of the main body thereby allowing the heat shrink to collapse thereinto upon application of heat during assembly of the fiber optic connector.

6. The fiber optic connector of claim 1, wherein the main body further comprises an anti-buckle feature disposed between the closed latch mechanism and the main body and located forward of the transition portion.

7. The fiber optic connector of claim 6, wherein the anti-buckle feature is on the main body.

8. The fiber optic connector of claim 6, wherein the anti-buckle feature is on the closed latch mechanism.

9. The fiber optic connector of claim 1, wherein the at least two optical fibers include exactly two optical fibers each terminated in respective LC-type ferrules supported by the housing.

10. The fiber optic connector of claim 1, wherein the at least two optical fibers include at least three optical fibers terminated in a single multi-fiber ferrule supported by the housing.

11. The fiber optic connector of claim 10, wherein the housing comprises a ferrule receiver configured to seat the single multi-fiber ferrule therein.

12. The fiber optic connector of claim 10, wherein the at least two optical fibers transition from a loose arrangement to ribbonized arrangement inside the main body at the transition portion.

13. The fiber optic connector of claim 1, wherein the housing is a two-piece housing.

14. The fiber optic connector of claim 2, wherein the stiffening rib is on an outside surface of the closed latch mechanism.

15. The fiber optic connector of claim 2, wherein the stiffening rib is on an underside surface of the closed latch mechanism.

16. The fiber optic connector of claim 1, wherein the rear end of the closed latch mechanism is lower than the front end of the closed latch mechanism between the top wall and the bottom wall of the housing.

17. The fiber optic connector of claim 1, wherein the housing includes an internal forward facing surface to engage a spring.

18. The fiber optic connector of claim 1, wherein a rear portion of the closed latch mechanism including the rear end thereof is smooth up to a junction with the housing.

19. A bag of parts comprising the housing of claim 1 with the closed latch mechanism integrally molded with the housing.

20. The fiber optic connector of claim 1, wherein upon a full insertion into a telecommunication structure, at least a rear portion of the closed latch mechanism is exposed and is compliant to deflect between the first position and the second position.
